(19) United States
(12) Patent Application Publication
(10) Pub. No.: US 2012/0064230 A1
(43) Pub. Date: Mar. 15, 2012

(54) METHOD FOR FORMING CONDUCTIVE VIA IN A SUBSTRATE

(76) Inventors: Shih-Long Wei, Yonghe City (TW); Sheng-Li Hsiao, Yonghe City (TW); Chien-Hung Ho, Yonghe City (TW); Hsiao-Chun Liu, Yonghe City (TW)

(21) Appl. No.: 12/880,168

(22) Filed: Sep. 13, 2010

(51) Int. Cl. B05D 5/12; C25D 5/02

(52) U.S. Cl. 427/96.9; 205/118

(57) ABSTRACT

The steps of the present invention are as follows: (a) a detachable film is formed on both sides of a substrate, respectively; (b) a number of vias running through both sides of the detachable films are formed in the substrate; (c) the vias are filled with a conductive paste; (d) the detachable films are peeled off; (e) a metallic conductive layer is deposited on both sides of the substrate, respectively; (f) a specific mold pattern is formed on the metallic conductive layers, respectively, by a photolithographic process; (g) a metallic circuit layout layer is formed on the patterns, respectively, by an electrochemical process; and (h) the mold patterns and the metallic conductive layers are removed. As such, the substrate is not contaminated by the conductive paste. Further, by using deposition, metallic conductive layers are directly adhered to the substrate and, by using photolithography, layouts with small linewidth could be formed.

### (a) TECHNICAL FIELD OF THE INVENTION

The present invention generally relates to die packaging, and more particular to a method for forming conductive vias in a substrate which is provided for die packaging.

### (b) DESCRIPTION OF THE PRIOR ART

Light emitting diodes (LEDs) have been widely applied in daily life such as traffic lights, various motor vehicles' head and tail lights, street lights, flash lights, monitor back lights, etc. For the application of LEDs, a very important process is the so-called packaging which provides the necessary support for the required electricity, lighting, and dissipation of a LED die. For example, if the LED is to be exposed for an extended period of time in the atmosphere and the LED would age and deteriorate due to moisture and chemicals in the environment, the LED is usually wrapped in the packaging process by a highly transparent epoxy resin to isolate the LED from the environment. On the other hand, by selecting an appropriate substrate for the LED's packaging, superior heat dissipation and therefore high reliability for the LED could be achieved. Additionally, the lighting efficiency and lifetime of the LED could also be enhanced.

As shown in FIG. 1, to shorten the distance of electronic signal transmission, vias 10 are usually formed in the substrate 1. Then a metallic mask 12 is formed over the substrate 1 so that through channels of the metallic mask 12's are aligned with the vias 10. Subsequently, by a filling or vacuumed means, the visa 10 are filled with a conductive paste 14. A significant drawback of this approach is that it is difficult to align the through channels of the metallic mask 12 with the vias 10, especially for a large dimension of substrate where the accumulated error is increased.

Another common approach to form an electrically conductive via is to use electroplating for the filling in the vias 10. However, the process is complex, leading to long process time, high cost, and insufficient filling is still a risk. The more advanced pulse electrodeposition still achieves limited improvement and air bubbles in the vias could still be present. Additionally, the cost and space budget for a large number of power supplies during mass production could be significant.

### SUMMARY OF THE INVENTION

The major objectives of the present invention are as follows. First, by using detachable films, the films and the substrate are self-aligned at the location of the via and the filling of the conductive paste would not contaminate the substrate surfaces. There is therefore no need to clean the substrate surfaces after the filling process of the conductive paste. Further, by using deposition technology, metallic conductive layers are directly adhered to the substrate. In addition, by using photolithography, circuit layouts with small linewidth could be formed, significantly enhancing the layout density.

To achieve the objectives, the steps of the present invention are as follows: (a) a detachable film is formed on both sides of a substrate, respectively; (b) a number of vias running through both sides of the detachable films are formed in the substrate; (c) the vias are filled with a conductive paste; (d) the detachable films are peeled off; (e) a metallic conductive layer is deposited on both sides of the substrate, respectively; (f) a specific mold pattern is formed on the metallic conductive layers, respectively, by a photolithographic process; (g) a metallic circuit layout layer is formed on the patterns, respectively, by an electrochemical process; and (h) the mold patterns and the metallic conductive layers are removed.

Yet another objective of the present invention is that the metallic conductive layers are directly adhered, not just attached, to the substrate, so as to achieve superior coating strength.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing conductive paste filled in vias of a conventional substrate.

FIGS. 2a-2h are schematic diagrams showing the steps (a)-(h) of an embodiment of the present invention.

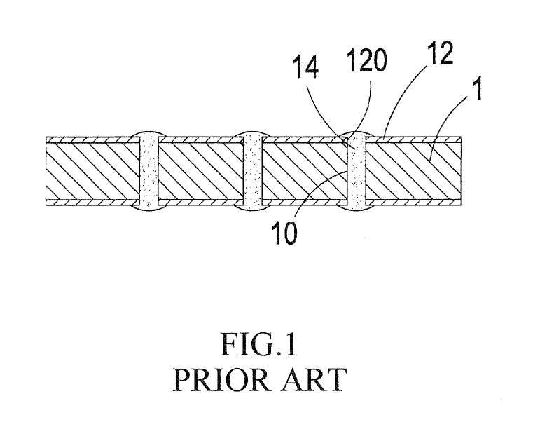

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

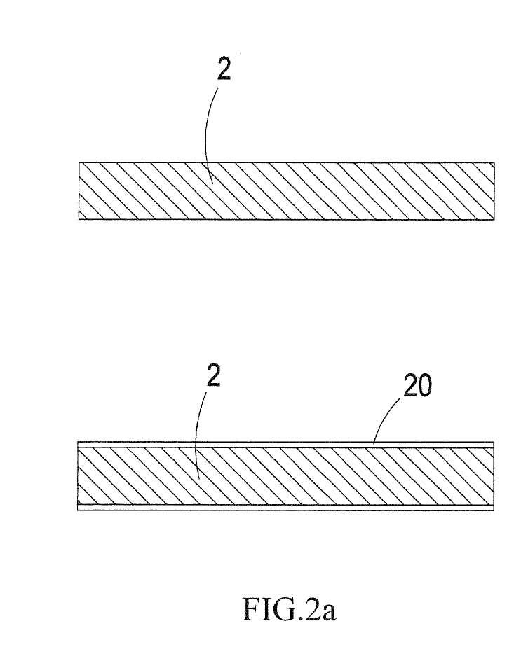

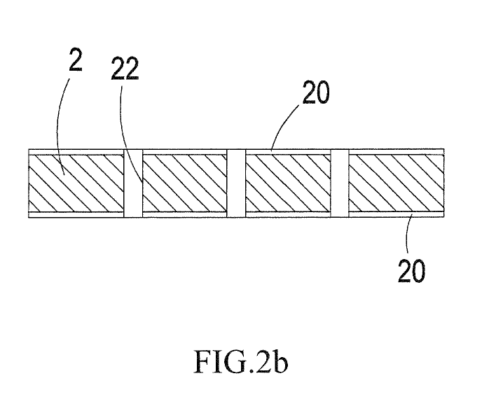

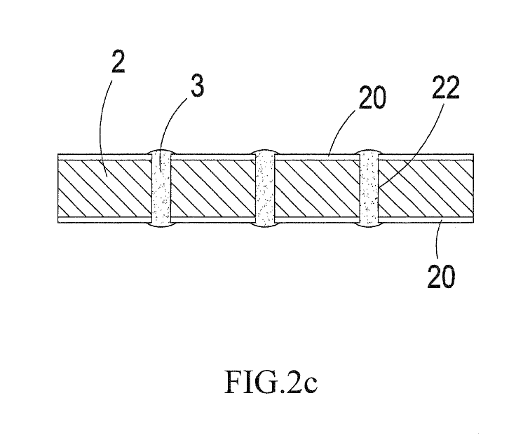

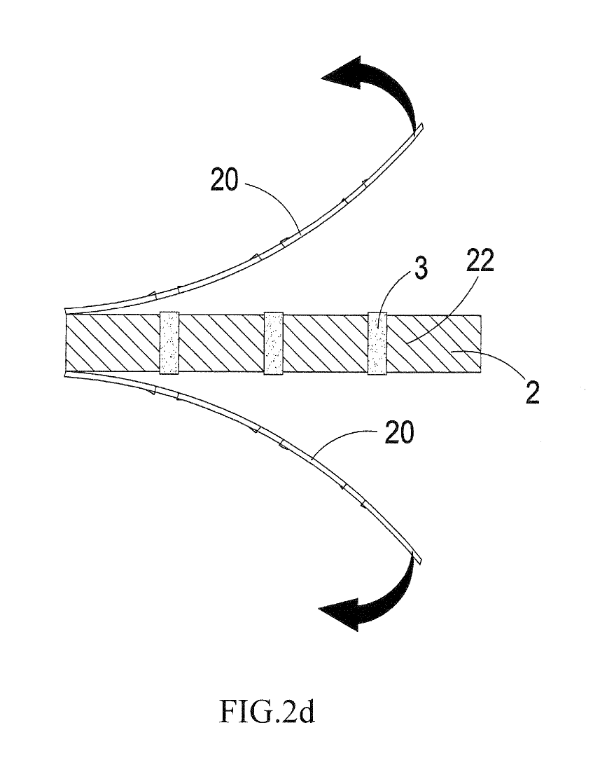

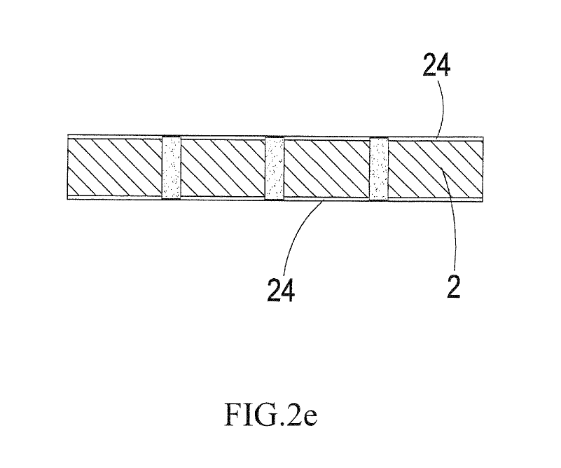

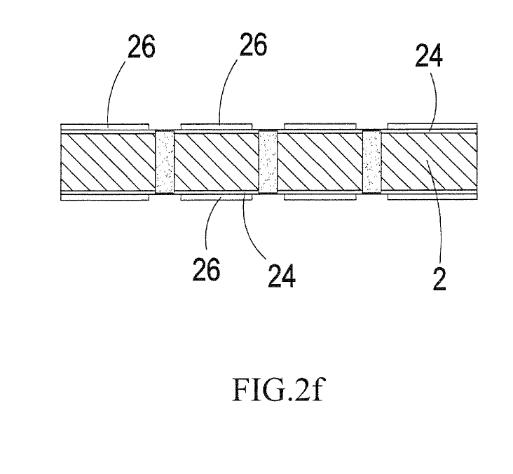

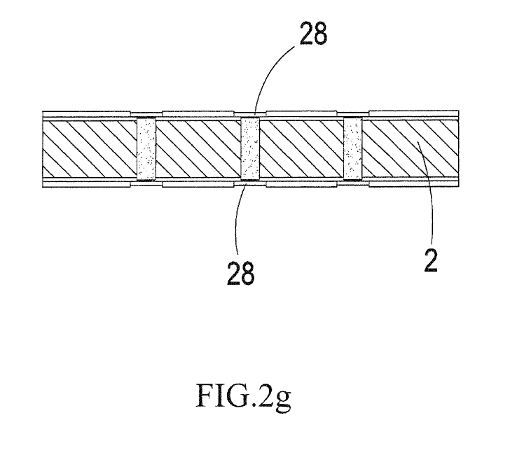

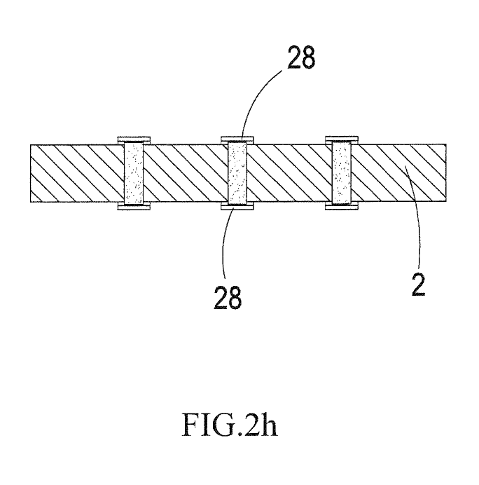

FIGS. 2a to 2h are schematic diagrams showing the steps (a) to (h) of a method for forming conductive vias in a substrate according to an embodiment of the present invention. In summary, the steps are as follows: (a) a detachable film is formed on both sides of a substrate, respectively; (b) a number of vias running through both sides of the detachable films are formed in the substrate; (c) the vias are filled with a conductive paste; (d) the detachable films are peeled off; (e) a metallic conductive layer is deposited on both sides of the substrate, respectively; (f) a specific mold pattern is formed on the metallic conductive layers, respectively, by a photolithographic process; (g) a metallic circuit layout layer is formed on the patterns, respectively, by an electrochemical process; and (h) the mold patterns and the metallic conductive layers are removed.

In step (a), a detachable film 20 is formed on both major sides of a substrate 2, respectively. Preferably, the substrate 2 is a ceramic substrate, such as an aluminum oxide or aluminum nitride substrate, due to its superior thermal conductivity. A ceramic substrate is capable of quickly dissipating heat produced from a high-powered LED die so that the LED die's lighting efficiency and lifetime are not adversely affected. In addition, a ceramic substrate is capable of sustaining harsh environment and its insulation makes it qualified as a substrate.

In step (b), for the substrate 2 with detachable films 20, a laser machining process is conducted to form a number of vias 22 running through the detachable films 20. The laser machining could be one using fiber laser, carbon dioxide laser, YAG laser, excimer laser, etc.

In step (c), the substrate 2 is placed on a working bench (not shown) and the vias 22 are completely filled with a conductive paste 3 until the conductive paste 3 is spilled over the detachable films 20. The conductive paste 3 could be filled into the vias 22 from one side of the substrate 2 or, to make sure that the vias 22 are fully filled, from both sides of the substrate 2. By the foregoing process, the present invention could avoid contamination to the substrate 2 and there is no need for mask alignment.

In step (d), the detachable films 20 are peeled off from both sides of the substrate 2. Due to the protection of the detachable films 20, the external surfaces of the substrate 2 beneath the detachable films 20 are not contaminated by the conductive paste 3 and there is no need to clean the substrate 2.

By the above steps, in addition to the prevention of substrate contamination from the conductive paste 3, the detachable films 20 and the substrate 2 are self-aligned at the location vias 22 and the conductive paste 3 could fully flow into the vias 22 without producing air bubbles. The machining equipment cost and production time could therefore both be reduced.

In step (e), a metallic conductive layer 24 is deposited on each side of the substrate 2 by, for example, sputtering which is used for the subsequent electroplating copper layout on the substrate 2. As the sputtering is conducted by the bombardment of Ar ions on a target material and the vaporized atoms of the target material which is driven out by the Ar ions directly deposit on the substrate 2, a number of advantages are achieved such as no contamination and superior adhesion.

In step (f), a specific mold pattern 26 is formed on the metallic conductive layers 24, by a photolithographic process. During the photolithographic process, using negative resist as an example, the exposed portion of photoresist undergoes a crosslinking change while the non-exposed portion would be resolved during development, leaving the exposed portion to form a specific mold pattern. The specific mold patterns 26 are thereby formed on the metallic conductive layers 24.

In step (g), a metallic circuit layout layer 28 is formed on each pattern 26 by an electrochemical process such as electroplating. As such, the metallic circuit layout layers 28 would have an appropriate thickness and ideal electrical and thermal conductivities.

As mentioned earlier, the detachable films 20 and the substrate 2 are self-aligned at the location of the vias 22 and the filling of the conductive paste 3 would not contaminate the substrate 2 surfaces. There is no need to clean the substrate surfaces.

Additionally, by using a ceramic material as substrate 2 and together with the metallic circuit layout layers 28, superior heat dissipation is achieved. On the other hand, the photolithographic process allows the circuit layout formation with small linewidth, contributing to a high layout density.

Finally, in step (h), the specific mold patterns 26 are removed to expose the metallic conductive layers 24. Then, an etching process is conducted to remove the metallic conductive layers 24 so that the circuits of the metallic circuit layout layers 28 are electrically insulated with each other.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for forming conductive vias in a substrate, comprising the steps of
forming a detachable film on both sides of said substrate, respectively;
forming a plurality of vias running through said detachable films;
filling said vias with a conductive paste;
peeling off said detachable films;
depositing a metallic conductive layer on both sides of said the substrate, respectively;
forming a specific mold pattern on said metallic conductive layers, and
forming a metallic circuit layout layer on said specific mold patterns.

2. The method according to claim 1, wherein said substrate is a ceramic substrate.

3. The method according to claim 1, further comprising the step of:
removing said specific mold patterns and said metallic conductive layers after said metallic circuit layout layers are formed so that said metallic circuit layout layers are insulated with each other.

4. The method according to claim 1, wherein said specific mold patterns are formed by a photolithographic process.

5. The method according to claim 1, wherein said metallic circuit layout layers are formed by an electrochemical process.
